(19) United States
(12) Patent Application Publication
(10) Pub. No.: US 2009/0314183 A1
(43) Pub. Date: Dec. 24, 2009

(54) Multi-component Starch Binder Compositions

(75) Inventor: Peeyush Tripathi, Scarborough, ME (US)

Correspondence Address: FISH & RICHARDSON PC, P.O. BOX 1022, MINNEAPOLIS, MN, 55440-1022, US

(73) Assignee: S.D. WARREN COMPANY, Boston, MA (US)

(21) Appl. No.: 12/144,981

(22) Filed: Jun. 24, 2008

(51) Int. Cl. D21H 19/54; B32B 29/06; C09D 103/02

(52) U.S. Cl. 106/206.1; 524/47; 428/537.5

(57) ABSTRACT

Compositions including various combinations of a starch, a plasticizer for the starch, a crystalline or crystallizable material, and an amphiphilic material for use as binders for coatings for paper and other surfaces are presented. Examples of such compositions include combinations of a starch and a crystalline or crystallizable material; a starch, a crystalline or crystallizable material, and a plasticizer; a starch, a plasticizer, a crystalline or crystallizable material, and an amphiphilic material; a starch, a crystalline or crystallizable material, and an amphiphilic material; a starch and an amphiphilic material. Also described are printable surfaces including a base material with the compositions for use as binder coatings described herein included within or coated on the base material. Further described are methods of making paper that include providing a base material and applying a composition for use as a binder coating as described herein onto the base material.

### BACKGROUND

Starch has been used as a cost-effective and renewable pigment binder for paper coating applications for hundreds of years. However, starch has many performance shortcomings when used as a paper coating binder including brittleness, moisture sensitivity, poor strength, low binding strength, and poor printability such as high back trap mottle and low ink film continuity. Chemical and mechanical starch modifications have managed to address various combinations of these shortcomings, however, these modifications increase the cost of the starch. Examples of such modifications include copolymerization with other film-forming monomers, functionalization of the starch backbone, pre-cross-linking, and the development of nano-sized starches. While these modifications have improved starch performance as a coating binder, there is still a noticeable gap between the performance of these modified starches and hydrocarbon based binders such as polyvinyl alcohol, styrene butadiene (SBR) based latex, polyvinyl acetate latexes, and styrene acrylate latexes.

### SUMMARY

Compositions including various combinations of a starch, a plasticizer for the starch, a crystalline or crystallizable material, and an amphiphilic material for use as binders for coatings for paper and other surfaces are described. The starch can be a hydroxy alkoxylated starch, such as an ethoxylated starch. The plasticizer can be a monomer such as sorbitol, polyethylene glycol, polypropylene glycol, copolymers of polyethylene glycol and polypropylene glycol, carrageenan, or derivatives or mixtures thereof. The crystalline or crystallizable material can be an organic material such as a polyol (e.g., pentaerythritol, mannitol, starch hydrolyzates, or derivatives or mixtures thereof). The amphiphilic material can be water soluble (e.g., a hyperbranched dendrimer). Useful combinations of these components include a starch and a crystalline or crystallizable material; a starch, a crystalline or crystallizable material, and a plasticizer; a starch, a plasticizer, a crystalline or crystallizable material, and an amphiphilic material; a starch, a crystalline or crystallizable material, and an amphiphilic material; a starch and an amphiphilic material.

An example of such a composition is a composition that includes between 48 percent by weight and 65 percent by weight of a starch, between 25 percent by weight and 45 percent by weight of a plasticizer, between 3 percent by weight and 7 percent by weight of a crystalline or crystallizable material, and between 0.15 percent by weight and 6 percent by weight of an amphiphilic material. An additional example of such a composition is a composition that includes about 60 percent by weight of an alkoxylated starch, about 35 percent by weight sorbitol, about 5 percent by weight mannitol, and about 2 percent by weight hyperbranched dendrimer.

Also described herein are printable surfaces including a base material with the compositions for use as binders for coatings described herein integrated into or coated onto the base material. Further described are methods of making paper that include providing a base material and applying a composition for use as a binder for a coating as described herein onto the base material.

### DETAILED DESCRIPTION

Multi-component compositions for use as binder coatings for paper and other surfaces are described herein. The compositions have excellent strength, controllable surface energy, and provide good printability. The compositions include various combinations of a starch, a plasticizer for the starch, a crystalline or crystallizable material, and an amphiphilic material.

As used herein the term starch includes any known starch or flour. Starches useful with the compositions described herein can be derived from any native source, as well as starches derived from plants obtained by standard breeding techniques, such as crossbreeding, translocation, inversion, transformation, or any other method of gene or chromosome engineering that include variations thereof. Additionally, starches derived from plants grown from artificial mutations or variations of the above generic composition produced by known standard methods of mutation breeding are also suitable for use with the compositions described herein. Any molecular weight starch can be used with the compositions described herein.

Typical sources of starches include cereals, tubers, roots, legumes, and fruits. Examples of starch sources include corn, pea, potato, sweet potato, banana, barley, wheat, maize, rice, sago, amaranth, tapioca, arrowroot, canna, sorghum, and waxy or high amylose varieties thereof. Waxy versions of these, especially maize, tapioca, and potato, are useful. The term waxy is intended to indicate a starch containing at least 95% by weight amylopectin and the term high amylose is intended to indicate a starch containing at least about 40% by weight amylose.

Modified versions of these starches are also useful. Modifications include physical or chemical modification of the base starch. More than one modification or type of modification may occur on a single base starch. Modified starches include, without limitation, cross-linked starches; stabilized starches (i.e., starches which do not undergo retrogradation under freeze-thaw conditions); acetylated and organically esterified starches; alkoxylated starches (particularly ethoxylated and propoxylated starches); hydroxyalkylated starches (particularly hydroxyethylated and hydroxypropylated starches); phosphorylated and inorganically esterified starches; cationic, anionic, nonionic, and zwitterionic starches; and succinate and substituted succinate starch derivatives. Modified starches also include those that have been acid or enzymatically etched. Such modifications and combinations thereof are known and their preparation are described in the art. See, e.g., Whistler, R. L., BeMiller, J. N. and Paschall E. F., STARCH CHEMISTRY AND TECHNOLOGY, 2 Ed., Academic Press, Inc., London, Ch. 9, § 3, pp. 324-349 (1984); MODIFIED STARCHES: PROPERTIES AND USES, Wurzburg, O. B., Editor, CRC Press, Inc., Florida (1986). An example of an ethoxylated starch is Ethylex 2020® (hydroxyethylated corn starch available from Tate and Lyle; London, England). Additional examples of modified starches include hydroxy ethoxylated and other starches from Penford Products Co. (Cedar Rapids, Iowa) such as Pen-cote®, PenFilm®, and Penford® Gum; hydroxy ethoxylated and other starches from National Starch & Chemical (Bridgewater, N.J.) such as StacKOTE®, KoFilm®, Cato-Size®, and FilmKote®; and hydroxy propoxylated and other starches from Cargill (Minneapolis, Minn.).

Plasticizers useful with the compositions described herein include plasticizers and humectants chosen for use with a particular starch. The plasticizers and humectants impart flexibility to the starch so that films formed from the compositions will be less brittle than pure starch films. Without wishing to be bound by theory, it is thought that the plasticizer acts similar to a Flory solvent for the starch making the starch molecules more relaxed during and after the starch film consolidation. Such relaxation of the starch molecules eliminates out-of-plane stresses enabling the formation of a very flat and moldable film.

Suitable plasticizers generally include any conventional plasticizer that decreases hardness and modulus, enhances pressure sensitive tack, and reduces melt and solution viscosity. Specifically, the plasticizers are chosen to enhance the film forming ability of the starch. Plasticizers with solubility parameters similar to the starch used will reduce phase separation during film consolidation as well as reduce in-plane stress on the starch molecules in a film. The minimization of these parameters results in excellent film formation properties. Film properties such as strength, elongation, and tensile energy absorption can be varied by adjusting the plasticizer level in the composition. The plasticizer can be a monomeric species or a polymeric species having a number average molecular weight of greater than 1,000 (number average molecular weight can be measured, for example, against polyethylene standards in tetrahydrofuran as a solvent). Examples of plasticizers include sorbitol, polyethylene glycol, polypropylene glycol, copolymers of polyethylene glycol and polypropylene glycol, carrageenan, and derivatives and mixtures thereof. Sorbitol, non-crystallizing sorbitol, and derivatives and mixtures thereof are particularly useful with the compositions described herein. Non-crystallizing sorbitol is useful in many situations because highly concentrated sorbitol solutions have a tendency to crystallize at room temperature. Non-crystallizing sorbitol solutions have an amount of other molecules such as sorbitol anhydrides or hydrogenated oligosaccharides that inhibit crystallization.

Mixtures of starch and plasticizer are often tacky rendering these compositions difficult to handle as well as reducing printability and optical properties. Such undesirable tackiness can be removed with small doses of crystalline or crystallizable materials. Tackiness reduction is useful in top coat application in which paper may undergo surface modification via, e.g., high temperature and pressure calendaring. Tackiness level is less of an issue in underlying layers as these layers are not directly contacted during calendaring. Crystalline or crystallizable materials useful with the compositions described herein include organic and inorganic materials that can crystallize in small domains during starch consolidation such that the crystallized domains do not reduce the starch strength. Examples of such crystalline or crystallizable materials include polyols. The dosage level of crystallizable material will be related to tackiness level which is impacted by factors such as moisture level, extent of latex replacement, and the pigment package. The use of polyols also alleviates other negative properties associated with the use of starch as a binder in paper coating formulations, e.g., polyols help improve paper gloss and heat set ink gloss. Examples of polyols useful in the compositions described herein include, but are not limited to, pentaerythritol, mannitol, and derivatives and mixtures thereof. Such polyols are commercially available, e.g., Pearlitol® mannitol (Roquette America, Inc.; Keokuk, Iowa), and pentaerythritol (Perstorp Polyols Inc.; Toledo, Ohio).

Other crystalline or crystallizable materials include starch hydrolyzates, and derivatives and mixtures thereof. The term starch hydrozylate refers to molecules created from the hydrolysis of starch molecules. Examples of individual starch hydrozylates include, for example, maltodextrin, dextrose, and various corn syrups. Starch hydrolysis can be accomplished with acids or various enzymes known to those of skill in the art. Depending on the hydrolysis reaction conditions, a starch hydrozylate composition can include a heterogeneous mixture of compounds. Starch hydrozylate mixtures and products are commercially available, e.g., Maltrin® maltodextrins (Grain Processing Corporation; Muscatine, Iowa) and Clintose® dextrose (Archer Daniels Midland Co.; Decatur, Ill.).

The compositions described herein also include an amphiphilic material. As used herein the term amphiphilic material means a material possessing both hydrophilic and hydrophobic properties. Without wishing to be bound by theory, when included in the compositions described herein these amphiphilic materials are believed to prevent or limit phase separation during starch consolidation. Stated another way, the amphiphilic materials are thought to allow a starch matrix to consolidate with the other components of the compositions described herein while maintaining a homogeneous distribution of the components. When included in the compositions described herein the amphiphilic material also acts to reduce the moisture sensitivity of the composition.

The simplest amphiphilic materials have a hydrophilic group and a hydrophobic group. The most common hydrophilic groups are charged groups or polar, uncharged (i.e., non-ionic) groups. The most common hydrophobic groups are alkanes and alkenes (e.g., unsaturated fatty acid chains). Surfactants are amphiphilic materials with a charged hydrophilic group and a hydrophobic group. Amphiphilic materials can include polymeric hydrophilic and/or hydrophobic portions with number average molecular weights of greater than about 1000 (number average molecular weight can be measured, for example, against polyethylene standards in tetrahydrofuran as a solvent). Amphiphilic materials also can include multiple hydrophobic and hydrophilic groups, e.g., dendrimeric molecules. Dendrimeric amphiphilic materials can be hyper branched and/or have hydrophilic and hydrophobic monomers arranged on the periphery of the dendrimer. A specific example of an amphiphilic dendrimer is Boltorn W3000 (Perstorp Polyols Inc.; Toledo, Ohio). The structure of Boltorn 3000 includes a dendritic backbone to which are attached hydrophobic and hydrophilic chains.

Amphiphilic materials useful with the compositions described herein include amphiphilic materials with a low hydrophilic-lipophilic balance (HLB). The HLB of an amphiphilic material is a measure of how much the amphiphilic material partitions into co-existing aqueous and oil phases. Amphiphilic materials with a low HLB are less dispersible in water than amphiphilic materials with a high HLB. Amphiphilic materials useful with the compositions described herein include low HLB amphiphilic dendrimers. The use of an amphiphilic material imparts hydrophobicity to the compositions which would otherwise be highly hygroscopic. The amphiphilic material can also improve printability if the amphiphilic material interacts with ink.

As described above, the compositions described herein include various combinations of a starch, a plasticizer, a crystalline or crystallizable material, and an amphiphilic material. Based on the properties and benefits discussed above, useful combinations of these components include a starch and a crystalline or crystallizable material; a starch, a crystalline or crystallizable material, and a plasticizer; a starch, a plasticizer, a crystalline or crystallizable material, and an amphiphilic material; a starch, a crystalline or crystallizable material, and an amphiphilic material; a starch and an amphiphilic material. The composition can comprise between 40 percent by weight and 98 percent by weight starch. As used herein the phrase percent by weight refers to the weight percent of a particular component based on the overall weight of the composition, i.e., if the starch component weighs 40 g and the overall composition weight of all the components is 100 g, then the starch is 40 percent by weight. The starch can also comprise between 45 percent by weight and 95 percent by weight, between 45 percent by weight and 90 percent by weight, between 45 percent by weight and 75 percent by weight, between 48 percent by weight and 65 percent by weight, between 58 percent by weight and 62 percent by weight, or about 60 percent by weight. The composition can comprise between 10 percent by weight and 50 percent by weight plasticizer. The plasticizer can also comprise between 20 percent by weight and 48 percent by weight, between 25 percent by weight and 45 percent by weight, between 30 percent by weight and 40 percent by weight, or about 35 percent by weight. The composition can comprise between 1 percent by weight and 10 percent by weight crystalline or crystallizable material. The crystalline or crystallizable material can also comprise between 2 percent by weight and 8 percent by weight, between 3 percent by weight and 7 percent by weight, between 4 percent by weight and 6 percent by weight, or about 5 percent by weight. The composition can comprise between 0.05 percent by weight and 9 percent by weight amphiphilic material. The amphiphilic material can also comprise between 0.1 percent by weight and 8 percent by weight, between 0.15 percent by weight and 6 percent by weight, between 0.15 percent by weight and 3 percent by weight, or about 2 percent by weight. The amount of amphiphilic material can also be based on the level of dry pigments in the total coating formulation. For example, the amount of amphiphilic material can comprise between 0.05 percent by weight and 1.5 percent by weight amphiphilic material based on the level of dry pigments in the total coating formulation. The amphiphilic material can also comprise between 0.1 percent by weight and 1.3 percent by weight, between 0.15 percent by weight and 1 percent by weight, between 0.15 percent by weight and 0.5 percent by weight, or about 0.25 percent by weight based on the level of dry pigments in the total coating formulation.

An example of a composition as described herein includes between 48 percent by weight and 65 percent by weight of the starch, between 25 percent by weight and 45 percent by weight of the plasticizer, between 3 percent by weight and 7 percent by weight of the crystalline or crystallizable material, and between 0.15 percent by weight and 6 percent by weight of the amphiphilic material. Another example of a composition as described herein includes between 58 percent by weight and 62 percent by weight of the starch, between 30 percent by weight and 40 percent by weight of the plasticizer, between 4 percent by weight and 6 percent by weight of the crystalline or crystallizable material, and between 0.15 percent by weight and 3 percent by weight of the amphiphilic material. A further example of a composition as described herein includes about 60 percent by weight of alkoxylated starch, about 35 percent by weight sorbitol, about 5 percent by weight mannitol, and about 2 percent by weight hyper branched dendrimer. An additional example of a composition as described herein includes an ethoxylated starch, a non-crystallizing sorbitol or a derivative thereof, mannitol or a derivative thereof, and a dendrimer.

As mentioned above, the compositions described herein are useful as binders in pigment coatings. These coatings can be coated on, or integrated into, a base material. One form of such a base material is a piece of paper, but a base can be any surface upon which printing is desired. The compositions described herein also can be used in edible films for food wrapping, as coatings for medical tablets, and as coatings for devices made from thermoplastics. While these compositions are useful for the replacement of latex containing binders, the compositions described herein could also be used to partially replace binders from other existing coating formulations.

The compositions described herein can be cooked in a batch or jet starch cooker. For example, a slurry of a composition as described herein can be combined at a 15-45% total solids level then cooked in a batch or jet starch cooker. Individual components can be mixed prior to addition to a batch or jet cooker or directly added to the cooker.

A method for making a printable surface includes providing a base material and applying a composition as described herein to the surface. The compositions can be prepared as aqueous or other solutions for application to a surface. Application of the compositions can be applied using techniques and apparatus well known in the art such as, for example, a blade coater, a rod coater, a pre-metered size press, an air knife coater, a curtain coater, a gate coater, a spray coater, an extruder, or application during a calendaring process. As just mentioned, the substrate can be paper or another substrate upon which printing is desired. The compositions as described herein can be used as the top layer or subsurface layers.

### EXAMPLES

### Example 1

Fifteen example compositions were prepared and physical properties were measured. In each composition the starch was Ethylex 2020® (Tate and Lyle; London, England); the plasticizer was sorbitol (Archer Daniels Midland Co.; Decatur, Ill.); the crystalline or crystallizable material was mannitol (Rhoquette Inc.; Keokuk, Iowa); and the amphiphilic material was Boltorn W3000 (Perstorp Polyols Inc.; Toledo, Ohio). The sample formulations generated for analysis are shown in Table 1.

For each composition prepared as indicated in Table 1, the composition was prepared as an aqueous solution at 30-40% total solids and batch cooked in a laboratory starch cooker (modified Agarmatic AS10, New Brunswick Scientific; Edison, N.J.). Films were cast from the aqueous solutions of a Mylar substrate using a grader knife and dried under ambient conditions. Then, for each example film prepared, tensile strength (lbs.), elongation (%), and total energy absorbed (TEA) (lbs.inch) were measured using a tensile tester (Model 1120, Instron; Norwood, Mass.).

The strength properties exhibited for the compositions in Table 1 indicate that the compositions described herein do not exhibit the common short comings in strength properties of starch, specifically, the compositions described herein exhibit good flexibility and tensile energy absorption (TEA) and that the properties for the compositions described herein approach those of synthetic binders such as SBR latexes. The results indicate that the compositions will behave similar to synthetic binder coatings for traditional paper coatings and on other surfaces. Composition 15 for example had very desirable overall performance as a binder for use as a paper coating formulation. The performance of these formulations demonstrates that these formulations can successfully replace synthetic binder from coating formulations.

### Example 2

Pilot scale trials were run using Composition 15 from Example 1 to determine the ability of Composition 15 to partially replace SBR latex (RAP 168; Dow Chemical Company; Midland, Mich.) in a binder coating formulation. Each binder composition was jet cooked (custom pilot scale unit manufactured by ProFlow Inc.; North Haven, Conn.) and mixed with coating pigments and other additives (calcium carbonate (60 parts by weight (“pbw”)); clay (40 pbw); lubricant (0.17 pbw); glyoxal cross linker (5% by weight of starch); rheology modifier (0.12 pbw); NaOH (as needed for pH control)) in a Kady mill. Each coating formulation was coated on paper using a pilot scale roll applicator/bent blade coater. The machine runnability (i.e., how well a paper runs on a printing press) and on-line calendaring for these compositions were measured (see Table 2). When compared to the control composition containing 100% latex, the performance of these compositions is shown to be similar. The results shown in Table 2 demonstrate that the binder compositions such as Composition 15 can be used to replace latex containing binders.

### Example 3

Pilot scale trials were run with various compositions as described in Table 3 to determine the ability to replace SBR latex in a binder coating formulation (other components are the same as listed above for Example 1). Each binder composition was jet cooked and mixed with coating pigments and other additives in a Kady mill as in Example 2. Each coating formulation was coated on paper using a pilot scale roll applicator/bent blade coater. The machine runnability (i.e., how well a paper runs on a printing press) and on-line calendaring for these compositions were measured (see Table 4). When compared to the control composition containing latex, the performance of these compositions is shown to be equivalent and in some categories (e.g., gloss) better. The results shown in Table 4 demonstrate that these binder compositions can be used to replace latex containing binders.

Any patents or publications mentioned in the specification are indicative of the level of those skilled in the art. These patents and publications are herein incorporated by reference in their entirety to the same extent as if each individual publication was specifically and individually indicated to be incorporated by reference.

The compositions, apparatus, and methods of the appended claims are not limited in scope by the specific compositions, apparatus, and methods described herein, which are intended as illustrations of a few aspects of the compositions, apparatus, and methods of the claims and any compositions, apparatus, and methods which are functionally equivalent are within the scope of this disclosure. Various modifications of the compositions, apparatus, and methods in addition to those shown and described herein will become apparent to those skilled in the art and are intended to fall within the scope of the appended claims. Further, while only certain representative combinations of the compositions, apparatus, and of the method steps disclosed herein are specifically described, other combinations of the apparatus components and method steps will become apparent to those skilled in the art and also are intended to fall within the scope of the appended claims. Thus a combination of components or steps may be explicitly mentioned herein; however, all other combinations of components and steps are included, even though not explicitly stated. The term comprising and variations thereof as used herein is used synonymously with the term including and variations thereof and are open, non-limiting terms.

TABLE 1
Example Compositions

| | Formulation (%) | | | | Strength Properties | | |
|---|---|---|---|---|---|---|---|
| | | | Crystalline or | Amphiphilic | Tensile | Elongation | TEA |
| Composition | Starch | Plasticizer | Crystallizable Material | Material | (lbs) | (%) | (lbs · inch) |
| 1 | 60 | 35 | 4 | 1 | 0.56 | 45.5 | 3.25 |
| 2 | 50 | 44.2 | 5.2 | 0.6 | 0.47 | 53.2 | 3.87 |
| 3 | 57.5 | 37.4 | 4.5 | 0.6 | 0.56 | 50.5 | 3.42 |
| 4 | 57.4 | 35 | 7 | 0.6 | 0.72 | 26 | 3.23 |
| 5 | 50 | 45 | 4 | 1 | 0.5 | 62 | 2.74 |
| 6 | 50 | 42.8 | 7 | 0.3 | 0.52 | 25.6 | 2.77 |
| 7 | 52.4 | 42.4 | 4.5 | 0.8 | 0.64 | 35.7 | 2.96 |
| 8 | 50 | 42.8 | 7 | 0.3 | 0.61 | 18.1 | 2.57 |
| 9 | 57.4 | 35 | 7 | 0.6 | 0.86 | 23.6 | 3.73 |
| 10 | 55.2 | 40.2 | 4 | 0.5 | 0.69 | 44.4 | 3.92 |
| 11 | 50.1 | 45.7 | 4 | 0.3 | 0.48 | 43.2 | 3.09 |
| 12 | 60.7 | 35.1 | 4 | 0.3 | 0.64 | 33.3 | 2.79 |
| 13 | 50 | 42 | 7 | 1 | 0.39 | 40.2 | 2.57 |
| 14 | 54.3 | 39.3 | 5.5 | 1 | 0.62 | 26.8 | 4.03 |
| 15 | 60 | 35 | 5 | 0.25 | 0.87 | 48.64 | 5.45 |

TABLE 2
Partial Replacement of SBR Latex in Coating Compositions

| | Control | 30% latex | 40% Latex |
|---|---|---|---|
| | formulation | reduction | reduction |
| Total Binder¹ | 13.25 | 15.00 | 15.00 |
| Latex | 8.75 | 6.10 | 5.25 |
| Starch | 4.50 | 5.14 | 5.65 |
| Plasticizer | 0.00 | 3.12 | 3.41 |
| Crystallizable | 0.00 | 0.45 | 0.49 |
| polyol | | | |
| Boltorn W3000 | 0.00 | 0.20 | 0.20 |
| CW² | 6 lbs/side | 6 lbs/side | 6 lbs/side |
| PPS³ | 0.89 | 1.03 | 1.04 |
| Gloss 75⁴ | 68.38 | 64.75 | 65.08 |
| HSIG 75⁵ | 93.20 | 89.08 | 88.58 |
| Proprietary | 6.8 | 6.6 | 6.2 |
| LodCel # Passes⁶ | | | |
| Proprietary IGT⁷ | 0.83 | 0.96 | 0.96 |
| Opacity⁸ | 87.35 | 86.90 | 87.20 |

¹Parts per hundred of total coating composition.
²Coat weight.
³Parker Print-Surf (Profile Plus (Technidyne Corp.; New Albany, IN)).
⁴Gloss at 75 degrees (Model T 4808 Glossmeter (Technidyne Corp.)).
⁵Heat Set Ink Gloss at 75 degrees (Model T 4808 Glossmeter).
⁶Number of passes inking before coating failure (Sappi proprietary test procedure).
⁷Proprietary IGT pick test (Model Global Standard Tester P (IGT Testing Systems Inc.; Arlington Heights, IL)).
⁸Opacity (Model 425 Opacity Tester (Technidyne Corp.)).

TABLE 3
Replacement of SBR Latex in Coating Formulations

| | Binder | SBR | | | Crystalizable | Boltorn | | Drying |
|---|---|---|---|---|---|---|---|---|
| Run No. | level¹ | Latex² | Starch² | Plasticizer² | polyol² | W3000² | Moisture % | type |
| 1 | 12 | 0 | 7.2 | 4.2 | 0.6 | 0.1 | 3.5 | Early |
| 2 | 16 | 0 | 9.6 | 5.6 | 0.8 | 0.2 | 3.5 | Even |
| 3 | 16 | 0 | 9.6 | 5.6 | 0.8 | 0.1 | 4.5 | Early |
| 4 | 14 | 0 | 8.4 | 4.9 | 0.7 | 0.2 | 3.5 | Early |
| 5 | 12 | 0 | 7.2 | 4.2 | 0.6 | 0.1 | 4.5 | Even |
| 6 | 12 | 0 | 7.2 | 4.2 | 0.6 | 0 | 3.5 | Early |
| 7 | 14 | 0 | 8.4 | 4.9 | 0.7 | 0 | 4.5 | Early |
| 8 | 14 | 0 | 8.4 | 4.9 | 0.7 | 0.1 | 4.5 | Early |
| 9 | 16 | 0 | 9.6 | 5.6 | 0.8 | 0 | 3.5 | Early |
| 10 | 12 | 0 | 7.2 | 4.2 | 0.6 | 0.2 | 3.5 | Even |
| 11 | 16 | 0 | 9.6 | 5.6 | 0.8 | 0 | 4.5 | Even |
| 12 | 12 | 0 | 7.2 | 4.2 | 0.6 | 0.2 | 4.5 | Early |
| 13 | 16 | 0 | 9.6 | 5.6 | 0.8 | 0.1 | 3.5 | Even |
| 14 | 14 | 0 | 8.4 | 4.9 | 0.7 | 0.2 | 4.5 | Even |
| 15 | 14 | 0 | 8.4 | 4.9 | 0.7 | 0 | 3.5 | Even |
| Control | 14 | 4.5 | 9.5 | 0 | 0 | 0 | 3.5 | Early |

¹Percent binder level in coating composition.
²Percent of component in total coating composition.

TABLE 4
Properties for Coating Formulations of Table 2

| | | | 75 Paper | Slope | # Passes | | HSIG | IFC |
|---|---|---|---|---|---|---|---|---|
| Run No. | IGT¹ | PPS² | Gloss³ | MD⁴ | MD⁵ | Opacity⁶ | 75⁷ | heat set⁸ |
| 1 | 0.38 | 1.24 | 55.37 | 12.87 | 5.00 | 87 | 85 | 633 |
| 2 | 0.92 | 1.07 | 56.73 | 8.37 | 4.33 | 87.1 | 88 | 655 |
| 3 | 0.96 | 1.04 | 64.00 | 6.70 | 5.33 | 86.8 | 94 | 499 |
| 4 | 0.75 | 0.93 | 61.30 | 9.00 | 3.67 | 87.3 | 90 | 521 |
| 5 | 0.76 | 0.92 | 64.13 | 7.67 | 3.67 | 86.9 | 92 | 521 |
| 6 | 0.42 | 1.09 | 58.37 | 11.03 | 4.00 | 85.8 | 88 | 564 |
| 7 | 0.67 | 1.15 | 56.30 | 7.70 | 5.33 | 87.2 | 83 | 733 |
| 8 | 0.80 | 1.01 | 64.50 | 7.17 | 5.33 | 86.7 | 93 | 514 |
| 9 | 0.91 | 1.06 | 59.67 | 5.90 | 6.33 | 86.6 | 91 | 817 |
| 10 | 0.62 | 0.93 | 63.40 | 10.43 | 4.33 | 86.6 | 90 | 542 |
| 11 | 1.10 | 1.03 | 64.47 | 6.07 | 6.00 | 86.9 | 93 | 537 |
| 12 | 0.78 | 0.89 | 65.40 | 10.47 | 3.67 | 87.7 | 93 | 482 |
| 13 | 0.78 | 1.05 | 58.73 | 6.63 | 5.00 | 86.7 | 85 | 658 |
| 14 | 1.04 | 0.89 | 66.70 | 7.57 | 4.33 | 87.3 | 94 | 436 |
| 15 | 0.76 | 1.05 | 59.37 | 6.23 | 5.33 | 86.7 | 88 | 569 |
| Control | 0.89 | 1.17 | 55.40 | 4.13 | 7.00 | 87.2 | 90 | 515 |

¹IGT pick test (Model Global Standard Tester P).
²Parker Print-Surf (Profile Plus).
³Gloss at 75 degrees (Model T 4808 Glossmeter).
⁴Slope from LodCel test.
⁵Number of passes inking before coating failure (Sappi proprietary test procedure).
⁶Opacity (Model 425 Opacity Tester).
⁷Heat Set Ink Gloss at 75 degrees (Model T 4808 Glossmeter).
⁸Ink Film Continuity (heat set).

What is claimed is:

1. A composition comprising:
a starch; and
a crystalline or crystallizable material.

2. The composition of claim 1, further comprising an amphiphilic material.

3. The composition of claim 1, further comprising a plasticizer for the starch.

4. The composition of claim 3, further comprising an amphiphilic material

5. The composition of claim 3, wherein the plasticizer is selected from the group consisting of sorbitol, polyethylene glycol, polypropylene glycol, copolymers of polyethylene glycol and polypropylene glycol, carrageenan, and derivatives and mixtures thereof.

6. The composition of claim 3, wherein the plasticizer comprises a non-crystallizing sorbitol or a derivative thereof.

7. The composition of claim 1, wherein the crystalline or crystallizable material comprises an organic material.

8. The composition of claim 1, wherein the crystalline or crystallizable material is selected from the group consisting of pentaerythritol, mannitol, starch hydrolyzates, and derivatives and mixtures thereof.

9. The composition of claim 2, wherein the amphiphilic material comprises a dendrimer.

10. The composition of claim 4, wherein the amphiphilic material comprises a dendrimer.

11. The composition of claim 4, wherein the starch is ethoxylated; the plasticizer comprises a non-crystallizing sorbitol or a derivative thereof; the crystalline or crystallizable material comprises mannitol or a derivative thereof; and the amphiphilic material comprises a dendrimer.

12. The composition of claim 1, wherein the composition has between 40 percent by weight and 98 percent by weight of the starch.

13. The composition of claim 3, wherein the composition has between 10 percent by weight and 50 percent by weight of the plasticizer.

14. The composition of claim 1, wherein the composition has between 1 percent by weight and 10 percent by weight of the crystalline or crystallizable material.

15. The composition of claim 4, wherein the composition has
between 48 percent by weight and 65 percent by weight of the starch;
between 25 percent by weight and 45 percent by weight of the plasticizer;
between 3 percent by weight and 7 percent by weight of the crystalline or crystallizable material; and
between 0.15 percent by weight and 6 percent by weight of the amphiphilic material.

16. An apparatus including a printable surface comprising:
a base material; and
the composition of claim 1 in and/or on the base material.

17. A method of making paper, the method comprising:
providing a base material; and
applying a composition of claim 1 to the base material.

18. A composition comprising:
a starch; and
an amphiphilic material.

19. The composition of claim 18, further comprising a plasticizer for the starch.

20. The composition of claim 18, wherein the amphiphilic material comprises a dendrimer.

21. The composition of claim 19, wherein the plasticizer is selected from the group consisting of sorbitol, polyethylene glycol, polypropylene glycol, copolymers of polyethylene glycol and polypropylene glycol, carrageenan, and derivatives and mixtures thereof.

22. The composition of claim 19, wherein the plasticizer comprises a non-crystallizing sorbitol or a derivative thereof.

23. The composition of claim 18, wherein the composition has between 40 percent by weight and 98 percent by weight of the starch.

24. The composition of claim 18, wherein the composition has between 0.05 percent by weight and 9 percent by weight of the amphiphilic material.

25. The composition of claim 19, wherein the composition has between 10 percent by weight and 50 percent by weight of the plasticizer.

26. An apparatus including a printable surface comprising:
a base material; and
the composition of claim 18 in and/or on the base material.

27. A method of making paper, the method comprising:
providing a base material; and
applying a composition of claim 18 to the base material.
